(19) United States
(12) Patent Application Publication
(10) Pub. No.: US 2018/0129308 A1
(43) Pub. Date: May 10, 2018

(54) INTERACTIVE DISPLAY APPARATUS AND OPERATING METHOD THEREOF

(71) Applicant: Coretronic Corporation, Hsin-Chu (TW)

(72) Inventors: CHENG-SHEN LEE, Hsin-Chu (TW); CHIH-NENG TSENG, Hsin-Chu (TW)

(21) Appl. No.: 15/714,847

(22) Filed: Sep. 25, 2017

(30) Foreign Application Priority Data
Nov. 4, 2016 (CN) 201610963146.5

(51) Int. Cl. G06F 3/038; G06F 3/0354; G06F 3/042

(52) U.S. Cl. CPC G06F 3/0386; G06K 9/78; G06F 3/0425; G06F 3/03542

(57) ABSTRACT

An interactive display apparatus includes a display device, an operation device and an image capture device. The display device displays image frames according to image signals from the host. The operation device includes a light source, a shutter and a plurality of function keys. The light source emits a light beam on the image frame. The shutter having a plurality of light transmissive areas with different shapes is located on a transmission path of the first light beam. The first light beam passes through the shutter to form an operation indicator on the image frame. When one of the function keys is triggered, the light transmissive area corresponding to the triggered function key is switched to be located on a transmission path of the light beam, thereby changing a shape of the operation indicator. The image capture device captures the image frame and the operation indicator on the image frame.

### CROSS-REFERENCE TO RELATED APPLICATION

THIS APPLICATION CLAIMS THE PRIORITY BENEFIT OF CN201610963146.5 FILED ON 2016 Nov. 4. THE ENTIRETY OF THE ABOVE-MENTIONED PATENT APPLICATION IS HEREBY INCORPORATED BY REFERENCE HEREIN AND MADE A PART OF THIS SPECIFICATION.

### FIELD OF THE INVENTION

The invention relates to a display apparatus, and more particularly to an interactive display apparatus and operating method thereof.

### BACKGROUND OF THE INVENTION

Among the various interactive electronic products, such as interactive projectors or interactive whiteboards, optical cameras (for example, a camera capable of detecting infrared light) are used to capture a light spot with a particular wavelength (e.g., a light spot of infrared light) displayed on a screen or a display, therefore a general projector or display device and the like can be converted into an interactive product. The sources for generating the above light spot on a projection screen or a display are, for example, a self-illumination light source, an infrared light generator, or an active light pen having a light emitting diode (LED) or a laser diode (visible light or invisible light).

However, an optical interactive projector equipped with a camera capable of detecting infrared light is usually required to perform an interactive touch operation with a projection screen in a close contact manner. Therefore, when an optical interactive projector is used for presentation, the user needs to stand at a position that his/her hand can touch the interactive projection screen so as to switch the slides or control a computer via the touch function. In addition, the conventional presentation pen (e.g., active light pen) still needs an additional wireless transmission module for data transmission and operation with the host. Therefore, how to improve the above-mentioned problems is the focus for the persons in the art.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

Therefore, one objective of the invention is to provide an interactive display apparatus, in which an operation device is used to change a shape of an operation indicator formed on an image frame and related instructions and functions are corresponding executed according to the shape of the operation indicator, thereby achieving the purpose of interactive operation.

Another objective of the invention is to provide an operating method of an interactive display apparatus, in which an operation device is used to change a shape of an operation indicator formed on an image frame and related instructions and functions are corresponding executed according to the shape of the operation indicator, thereby achieving the purpose of interactive operation.

Other objectives and advantages of the invention can be further illustrated by the technical features broadly embodied and described as follows.

In order to achieve one or a portion of or all of the objects or other objects, the invention provides an interactive display apparatus adapted to be electrically connected to a host. The interactive display apparatus includes a display device, an operation device and an image capture device. The display device is adapted to be electrically connected to the host and display an image frame according to an image signal provided by the host. The operation device includes a first light source, a shutter and a plurality of function keys. The first light source is adapted to emit a first light beam. The shutter has a plurality of light transmissive areas with different shapes. The shutter is located on a transmission path of the first light beam. The first light beam passes through the shutter to form an operation indicator on the image frame. The plurality of function keys are electrically connected to the shutter. When one of the function keys is triggered, the light transmissive area corresponding to the triggered function key is switched to be located on the transmission path of the first light beam, thereby changing a shape of the operation indicator. The image capture device is adapted to capture the image frame and the operation indicator formed on the image frame.

In order to achieve one or a portion of or all of the objects or other objects, the invention provides an operating method of an interactive display apparatus. The interactive display apparatus includes a display device, an operation device and an image capture device. The operation device includes a shutter and a plurality of function keys, and the shutter has a plurality of light transmissive areas with different shapes. The operating method includes steps of: controlling the display device to display an image frame; controlling the operation device to emit a first light beam on the image frame; forming an operation indicator on the image frame after the first light beam passing through the shutter; triggering one of the plurality of function keys of the operation device to switch the light transmissive area corresponding to the triggered function key to be located on a transmission path of the first light beam, thereby changing a shape of the operation indicator; and controlling the image capture device to capture the image frame and the operation indicator formed on the image frame.

In order to achieve one or a portion of or all of the objects or other objects, the invention provides an operation device. The operation device includes a first light source, a shutter and a plurality of function keys. The first light source is adapted to emit a first light beam on the image frame displayed by a display device. The shutter has a plurality of light transmissive areas with different shapes. The shutter is located on a transmission path of the first light beam. The first light beam passes through the shutter to form an operation indicator on the image frame. The plurality of function keys are electrically connected to the shutter. When one of the function keys is triggered, the light transmissive area corresponding to the triggered function key is switched to be located on the transmission path of the first light beam, thereby changing a shape of the operation indicator.

In summary, the interactive display apparatus of the embodiment of the invention utilizes the operation device to change the shape of the operation indicator formed on the image frame and correspondingly executes the related instruction and function according to the shape of the operation indicator formed on the image frame, thereby achieving the purpose of interactive control. The interactive display apparatus of the invention can realize the application of remote mutual touch control, and the operation device of the embodiment of the invention can perform interactive operation without a wireless transmission module.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic structural view of an interactive display apparatus in accordance with an embodiment of the invention;

FIG. 2 is a functional block view of the operation device shown in FIG. 1;

FIG. 3 is a schematic structural view of a shutter shown in FIG. 2;

FIG. 4 is a schematic view of the shutter of the embodiment in a use state;

FIG. 5 is a schematic view of the shutter of the embodiment in another use state;

FIG. 6 is a functional block view of an operation device in accordance with another embodiment of the invention;

FIG. 7 is a schematic structural view of an interactive display apparatus in accordance with another embodiment of the invention;

FIG. 8 is a schematic structural view of an interactive display apparatus in accordance with still another embodiment of the invention; and

FIG. 9 is a flow chart of an operating method of an interactive display apparatus in accordance with an embodiment of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

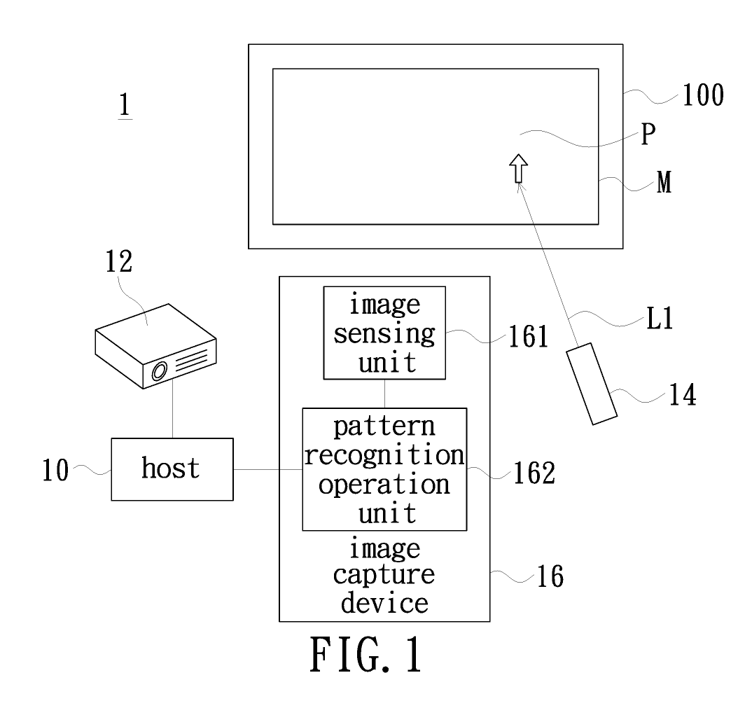

Please refer to FIG. 1, which is a schematic structural view of an interactive display apparatus in accordance with an embodiment of the invention. The interactive display apparatus 1 of the embodiment is adapted to be electrically connected to the host 10. In the embodiment, the host 10 is, for example, a personal computer, a notebook computer, a smart phone or a tablet computer, but the invention is not limited thereto. The interactive display apparatus 1 of the embodiment includes a display device 12, an operation device 14 and an image capture device 16. The display device 12 is adapted to be electrically connected to the host 10. The display device 12 displays an image frame M on a projection surface 100 according to an image signal provided by the host 10. In the embodiment, the display device 12 is, for example, a projector, the projection surface 100 is, for example, a projection screen, a wall or any suitable surface; but the invention is not limited thereto. The operation device 14 is adapted to emit a first light beam L1 onto the image frame M displayed on the projection surface 100 to form an operation indicator P. In the embodiment, the operation device 14 is, for example, an active light pen, wherein the first light beam L1 is visible light or invisible light, but the invention is not limited thereto. The image capture device 16 is adapted to capture the image frame M displayed on the projection surface 100 and the operation indicator P formed on the image frame M. In the embodiment, the image capture device 16 is, for example, a video camera or a picture camera, but the invention is not limited thereto.

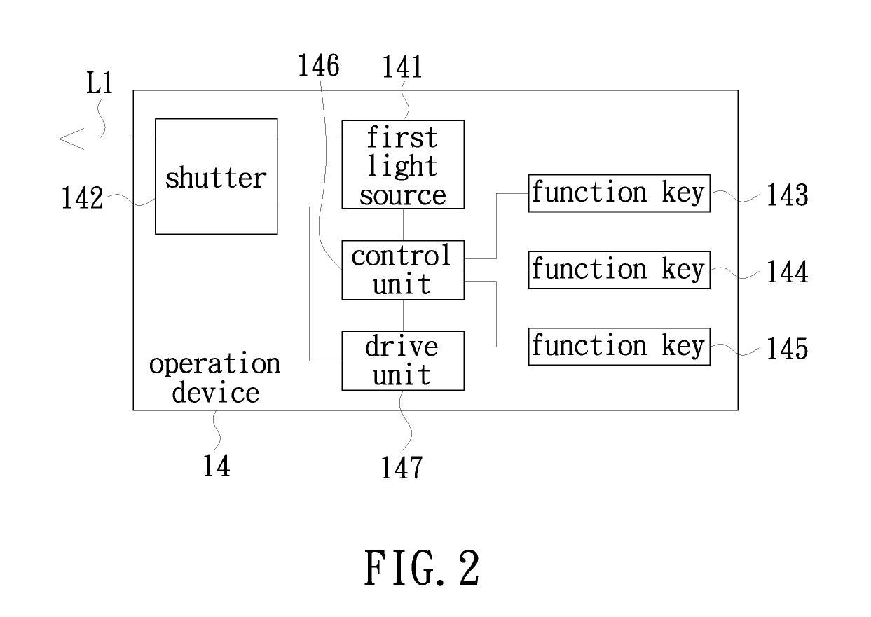

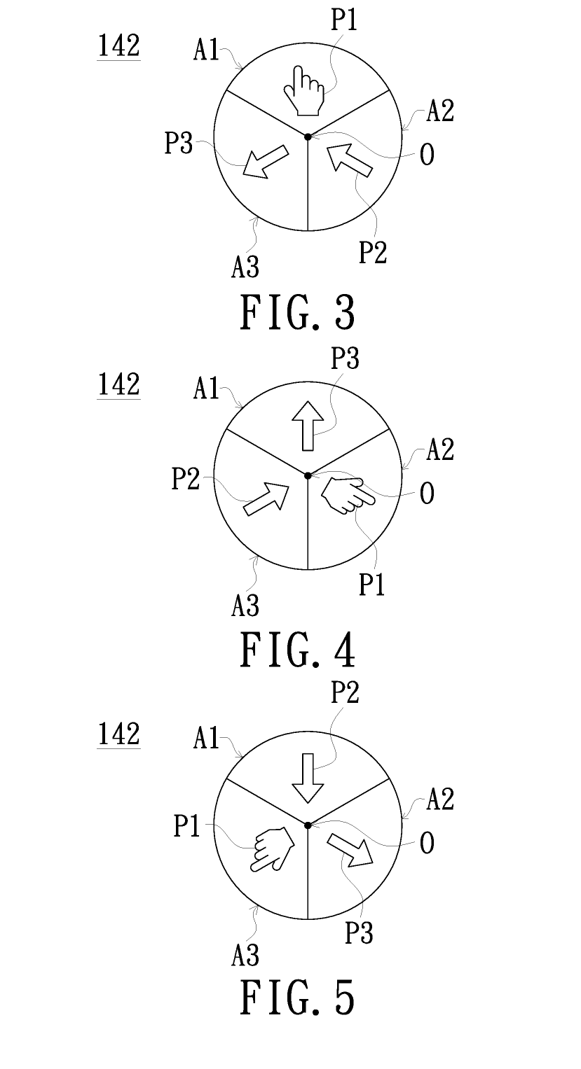

Please refer to FIGS. 2 and 3. FIG. 2 is a functional block view of the operation device 14 shown in FIG. 1. FIG. 3 is a schematic structural view of a shutter 142 shown in FIG. 2. As shown in FIGS. 1 to 3, the operation device 14 of the embodiment includes a first light source 141, the shutter 142 and a plurality of function keys 143, 144 and 145. The first light source 141 may be a solid state illuminated element such as a chip of light emitting diode (LED) or a laser diode chip, an encapsulated LED or a laser source. The first light source 141 is adapted to emit the first light beam L1 to form the operation indicator P on the image frame M. In the embodiment, the first light beam L1 is, for example, visible light, but the invention is not limited thereto. In other embodiments, the first light beam L1 may be invisible light (e.g., infrared light). The shutter 142 has, for example, a circular shape having a center O and includes a plurality of light transmissive areas P1, P2 and P3 with different shapes. The function keys 143, 144 and 145 are electrically connected to the shutter 142 and correspond to the light transmissive areas P1, P2 and P3 with different shapes respectively. Therefore, the shutter 142 is located on a transmission path of the first light beam L1. The first light beam L1 passes through the shutter 142 to form an operation indicator P on the image frame M.

When one of the function keys 143, 144 and 145 is triggered, for example, when the function key 143 is triggered, the light transmissive area P1 corresponding to the function key 143 is switched to be located on the transmission path of the first light beam L1; therefore, the first light beam L1 is changed to have a light shape same as the shape of the light transmissive area P1 and formed on the image frame M. The embodiment is described based on that the number of function keys and the number of light transmissive areas are three respectively. However, the invention does not limit the number of function keys and the number of light transmissive areas; that is, the number of function keys and the number of light transmissive areas may increase or decrease based on the actual requirements.

As shown in FIG. 2, the operation device 14 of the embodiment further includes a control unit 146 and a drive unit 147. The control unit 146 is electrically connected to the function keys 143, 144 and 145 and issues a control signal to the drive unit 147 in response to one of the function keys 143, 144 and 145 being triggered. The drive unit 147 is electrically connected to the shutter 142 and the control unit 147. The drive unit 147 receives the control signal from the control unit 146 and then drives the shutter 142 to rotate, so that the light transmissive area of the shutter 142 corresponding to the triggered function key is switched to be located on the transmission path of the first light beam L1. In the embodiment, the control unit 146 is, for example, a central processing unit (CPU) having a single core or a multi-core, a microprocessor or other similar component; the control unit 147 is, for example, a step motor or other suitable drive assemblies; and the invention is not limited thereto. The detailed operation of the operation device 14 switching the light transmissive areas P1, P2 and P3 of the shutter 142 to be located on the transmission path of the first light beam L1 will be described below.

Please refer to FIGS. 3 to 5 and FIGS. 1 to 2 together. FIG. 4 is a schematic view of the shutter 142 of the embodiment in a use state. FIG. 5 is a schematic view of the shutter 142 of the embodiment in another use state. Please refer to FIG. 3 first. The light transmissive areas P1, P2 and P3 with different shapes in the shutter 142 of the embodiment are located at a first position A1, a second position A2 and a third position A3 respectively. When the first light beam L1 emitted from the first light source 141 passes through the light transmissive area P1 at the first position A1, the first light beam L1 is changed by the light transmissive area P1 to have a cross-sectional shape same as the shape of the light transmissive area P1 and is irradiated on the image frame M. In the embodiment, the shape of the light transmissive area P1 is, for example, a finger pattern, and the finger pattern corresponds to an operation such as performing a clicking operation by the operation indicator P or a locus moving operation by the operation indicator P, but the invention is not limited thereto. Please refer to FIGS. 2 and 4. When the function key 144 is triggered, the control unit 146 issues a control signal to the drive unit 147 in response to the function key 144 being triggered. The drive unit 147 drives the shutter 142 to rotate with the center O as an axis after receiving the control signal, so as to move the light transmissive area P1 originally located at the first position A1 to the second position A2, to move the light transmissive area P2 originally located at the second position A2 to the third position A3, and to move the light transmissive area P3 originally located at the third position A3 to the first position A1. Thus, the first light beam L1 passing through the first position A1 is changed by the light transmissive area P3 to have a cross-sectional shape same as the shape of the light transmissive area P3 and is irradiated on the image frame M. In the embodiment, the shape of the light transmissive area P3 is, for example, an upward arrow, and the upward arrow corresponds to an operation such as performing an image upward scroll operation by the operation indicator P, but the invention is not limited thereto. Please refer to FIGS. 2 and 5. When the function key 145 is triggered, the control unit 146 issues a control signal to the drive unit 147 in response to the function key 145 being triggered. The drive unit 147 drives the shutter 142 to rotate with the center O as an axis after receiving the control signal, so as to move the light transmissive area P3 originally located at the first position A1 to the second position A2, to move the light transmissive area P1 originally located at the second position A2 to the third position A3, and to move the light transmissive area P2 originally located at the third position A3 to the first position A1. Thus, the first light beam L1 passing through the first position A1 is changed by the light transmissive area P2 to have a cross-sectional shape same as the shape of the light transmissive area P2 and is irradiated on the image frame M. In the embodiment, the shape of the light transmissive area P2 is, for example, a downward arrow, and the downward arrow corresponds to an operation such as performing an image downward scroll operation by the operation indicator P, but the invention is not limited thereto.

It is to be noted that the number and shape of the light transmissive areas of the shutter 142 may vary depending on the actual requirements and are not limited in the invention.

Please refer to FIG. 1 again. The image capture device 16 of the embodiment further includes an image sensing unit 161 and a pattern recognition operation unit 162. In the embodiment, the image sensing unit 161 is, for example, a charge coupled device (CCD), and the pattern recognition operation unit 162 is, for example, a graphics processing unit (GPU), but the invention is not limited thereto. The image sensing unit 161 is electrically connected to the pattern recognition operation unit 162, and the pattern recognition operation unit 162 is electrically connected to the host 10. The image sensing unit 161 is adapted to capture the image frame M displayed on the projection surface 100 and the operation indicator P formed on the image frame M and transmit the image frame M having the operation indicator P to the pattern recognition operation unit 162. The pattern recognition operation unit 162 is adapted to analyze the image frame M having the operation indicator P to obtain an analysis result and transmit the analysis result to the host 10. Then, the host 10 controls the display device 12 to display another image frame. For example, when the pattern recognition operation unit 162 determines that the shape of the operation indicator P on the image frame M is the finger pattern as shown in FIG. 3, the host 10 controls the display device 12 to display an image frame after an operation such as a clicking operation by the operation indicator P or a locus moving operation by the operation indicator P is performed. When the pattern recognition operation unit 162 determines that the shape of the operation indicator P on the image frame M is the upward arrow as shown in FIG. 4, the host 10 controls the display device 12 to display an image frame after an operation such as an image upward scroll operation by the operation indicator P is performed.

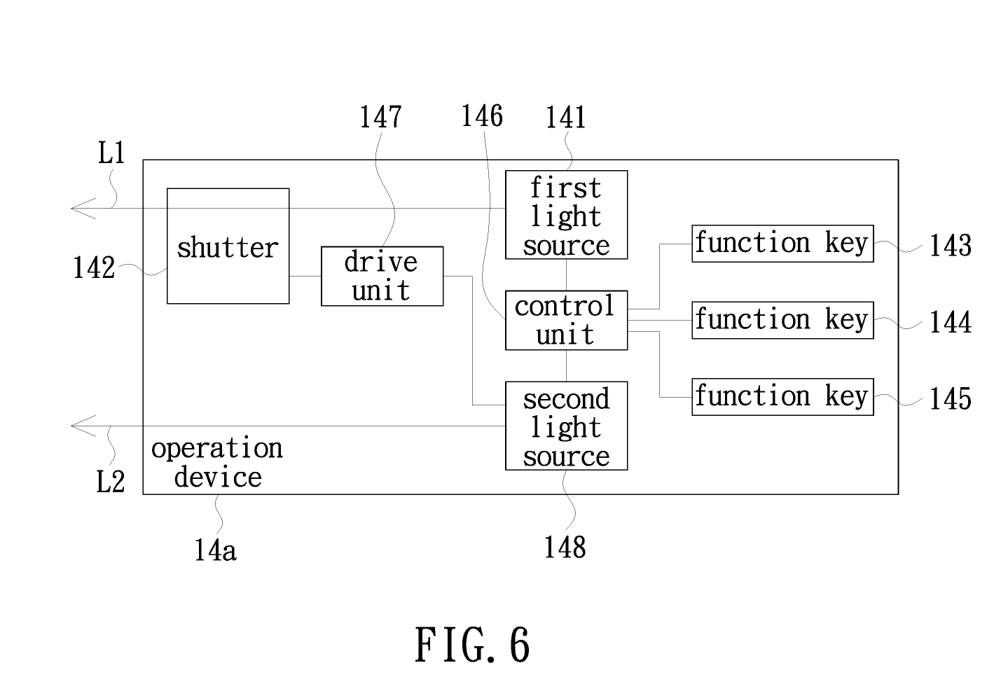

Please refer to FIG. 6, which is a functional block view of an operation device in accordance with another embodiment of the invention. The operation device 14a of the embodiment is similar to the operation device 14 shown in FIGS. 1 to 3, and the operation device 14a of the embodiment may also be constructed in the interactive display apparatus 1 shown in FIG. 1. The same elements are denoted by the same reference numerals, and no redundant detail is to be given herein. Please refer to FIGS. 2 and 6. The operation device 14a of the embodiment is different from the operation device 14 in FIGS. 1 to 3 in that the operation device 14a of the embodiment further includes a second light source 148. The second light source 148 is adapted to emit a second light beam L2. In the embodiment, the first light beam L1 emitted by the first light source 141 is, for example, visible light, and the second light beam L2 emitted by the second light source 148 is, for example, invisible light. In the embodiment, the operation device 14a can simultaneously emit the first light beam L1 as visible light and the second light beam L2 as invisible light. Therefore, the user can see the operation indicator P formed on the image frame M by the first light beam L1 during an operation process by utilizing the operation device 14a; and on the other hand, the operation indicator P formed on the image frame M by the second light beam L2 can be captured by the image capture device 16 (shown in FIG. 1, and is an image capture device capable of capturing invisible for example) for the interactive display apparatus 1 to capture or record the position of the operation indicator P. The second light source 148 may also be a solid state illuminated element such as a chip of LED or a laser diode chip, an encapsulated LED or a laser source, and the invention is not limited thereto.

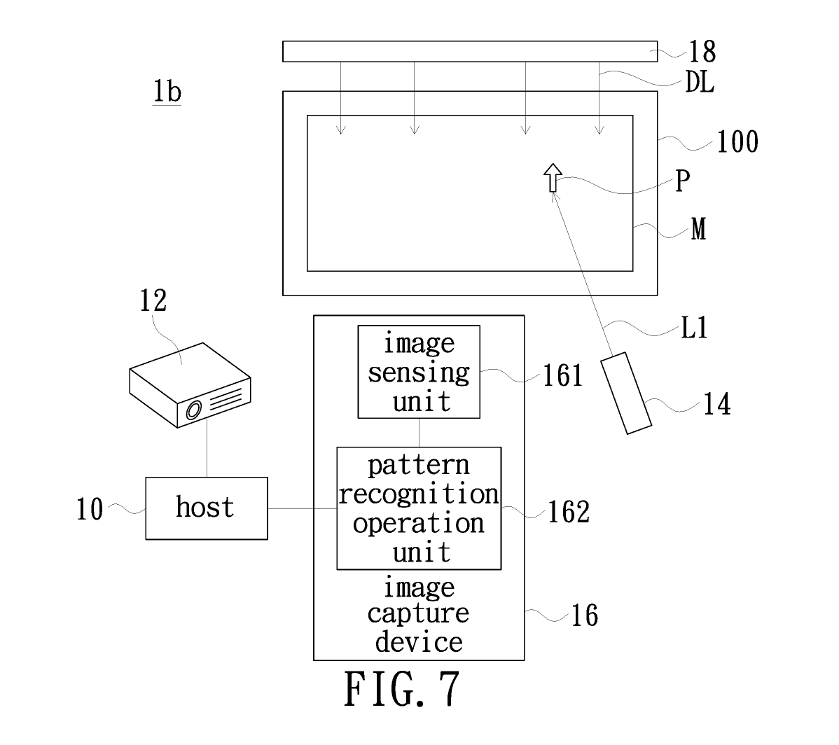

Please refer to FIG. 7, which is a schematic structural view of an interactive display apparatus in accordance with another embodiment of the invention. As shown in FIG. 7, the interactive display apparatus 1b of the embodiment is similar to the interactive display apparatus 1 shown in FIGS. 1 to 3. The same elements are denoted by the same reference numerals, and no redundant detail is to be given herein. The interactive display apparatus 1b of the embodiment is different from the interactive display apparatus 1 in that the interactive display apparatus 1b further includes at least one detection light source 18. The detection light source 18 is adapted to emit a detection light beam DL for detecting the projection surface 100. The detection light beam DL is, for example, parallel to the projection surface 100 and has a relatively small gap (not shown) with the projection surface 100. When a touch object (for example, a finger or a stylus) contacts with the projection surface 100 and is located within a detective range of the detection light beam DL, the image capture device 16 senses a reflection light of the detection light beam DL reflected by the touch object, and the host 10 determines a touch position of the touch object according to the reflection light. In the embodiment, the number of the detection light sources 18 is, for example, one. However, the invention does not limit the number of the detection light sources 18, and the number of the detection light sources 18 may vary depending on the actual requirements. In the embodiment, the detection light source 18 is, for example, a laser curtain module in which the light wavelength is invisible light, and the light intensity of the detection light beam DL is, for example, smaller than that of the first light beam L1, but the invention is not limited thereto.

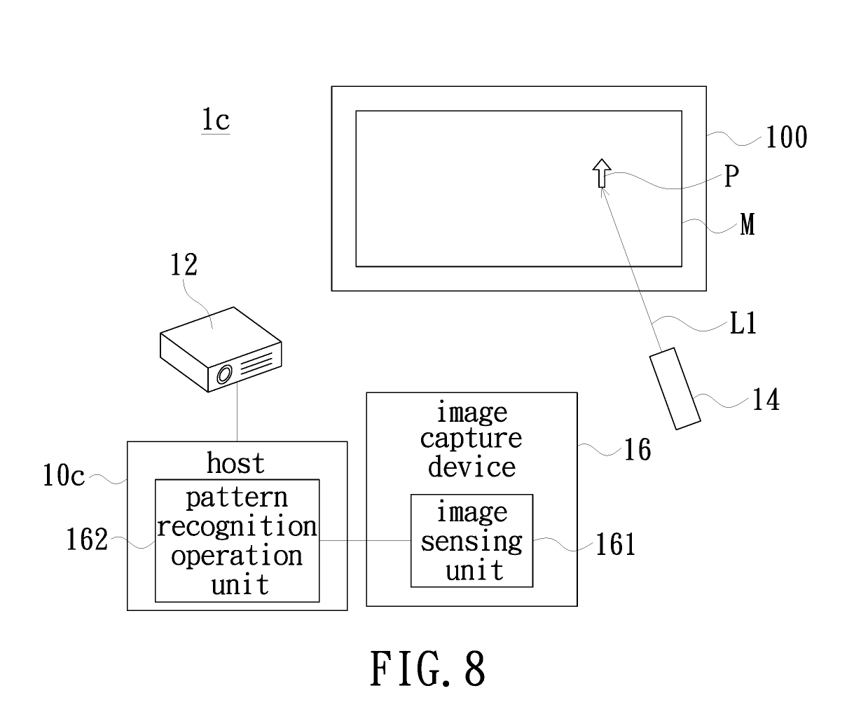

Please refer to FIG. 8, which is a schematic structural view of an interactive display apparatus in accordance with still another embodiment of the invention. As shown in FIG. 8, the interactive display apparatus 1c of the embodiment is similar to the interactive display apparatus 1 shown in FIGS. 1 to 3. The same elements are denoted by the same reference numerals, and no redundant detail is to be given herein. The interactive display apparatus 1c is different from the interactive display apparatus 1 in that the pattern recognition operation unit 162 of the interactive display apparatus 1c of the embodiment is disposed in the host 10c, thereby utilizing the powerful computing ability of the host 10c to improve the image analysis speed and enhance the real-time displaying of the displayed image. The pattern recognition operation unit 162 of the host 10c is electrically connected to the image sensing unit 161 of the image capture device 16. When the image sensing unit 161 of the image capture device 16 captures the image frame M displayed on the projection surface 100 and the operation indicator P formed on the image frame M, the image capture device 16 transmits the image frame M having the operation indicator P to the pattern recognition operation unit 162 of the host 10c. The pattern recognition operation unit 162 analyzes the image frame M having the operation indicator P to obtain an analysis result. Then, the host 10c controls the display device 12 to display another image frame. For example, when the pattern recognition operation unit 162 determines that the shape of the operation indicator P on the image frame M is the finger pattern as shown in FIG. 3, the host 10c controls the display device 12 to display an image frame after an operation such as a clicking operation by the operation indicator P or a locus moving operation by the operation indicator P is performed. When the pattern recognition operation unit 162 determines that the shape of the operation indicator P on the image frame M is the upward arrow as shown in FIG. 4, the host 10c controls the display device 12 to display an image frame after an operation such as an image upward scroll operation by the operation indicator P is performed.

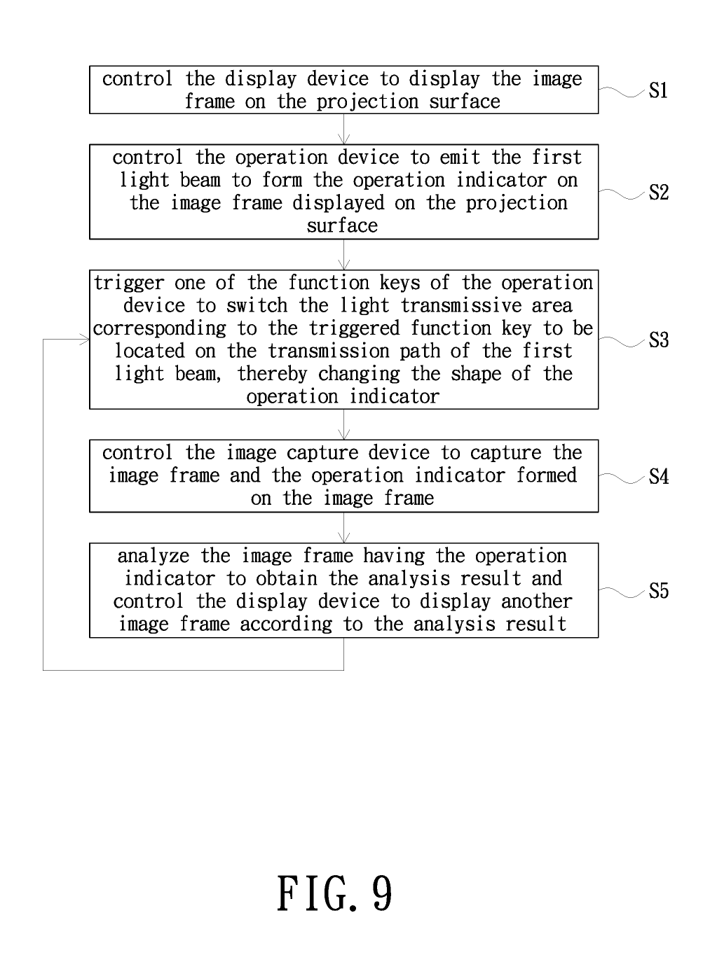

Please refer to FIG. 9, which is a flow chart of an operating method of an interactive display apparatus in accordance with an embodiment of the invention. Please refer to FIGS. 1-3 and 9 together. The operating method of the embodiment includes the following steps: first, as shown in step S1, controlling the display device 12 to display the image frame M on the projection surface 100; thereafter, as shown in step S2, controlling the operation device 14 to emit the first light beam L1 to form the operation indicator P on the image frame M displayed on the projection surface 100; thereafter, as shown in step S3, triggering one of the function keys (e.g., the function key 143, the function key 144 or the function key 145) of the operation device 14 to switch the light transmissive area corresponding to the triggered function key to be located on the transmission path of the first light beam L1, thereby changing the shape of the operation indicator P; thereafter, as shown in step S4, controlling the image capture device 16 to capture the image frame M and the operation indicator P formed on the image frame M; thereafter, as shown in step S5, analyzing the image frame M having the operation indicator P to obtain the analysis result and controlling the display device 12 to display another image frame according to the analysis result. For example, when the analysis result indicates that the shape of the operation indicator P on the image frame M is the finger pattern as shown in FIG. 3, the display device 12 is controlled to display an image frame after an operation such as a clicking operation by the operation indicator P or a locus moving operation by the operation indicator P is performed. The analysis result in step S5 is obtained by controlling the pattern recognition operation unit 162 of the image capture device 16 to analyze the image frame M having the operation indicator P, as shown in FIG. 1; or, the analysis result in step S5 is obtained by controlling the pattern recognition operation unit of the host 1 to analyze the image frame M having the operation indicator P, as shown in FIG. 8. When the analysis result indicates that the shape of the operation indicator P on the image frame M is the upward arrow as shown in FIG. 4, the display device 12 is controlled to display an image frame after an operation such as an image upward scroll operation by the operation indicator P is performed. It is to be noted that the operating method of an interactive display apparatus shown in FIG. 9 is not limited to be applicable to the interactive display apparatus 1 and the operation device 14 shown in FIGS. 1 to 3 only, but also applicable to the display device 1b shown in FIG. 7 and the display device 1c shown in FIG. 8. Further, the operation device 14a shown in FIG. 6 may be used to replace the operation device 14, but the invention is not limited thereto.

In summary, the interactive display apparatus of the embodiment of the invention utilizes the operation device to change the shape of the operation indicator formed on the image frame and correspondingly executes the related instruction and function according to the shape of the operation indicator formed on the image frame, thereby achieving the purpose of interactive control. The interactive display apparatus of the invention can realize the application of remote mutual touch control, and the operation device of the embodiment of the invention can perform interactive operation without a wireless transmission module.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first stop part, the second stop part, the first ring part and the second ring part are only used for distinguishing various elements and do not limit the number of the elements.

What is claimed is:

1. An interactive display apparatus adapted to be electrically connected to a host, the interactive display apparatus comprising:
a display device adapted to be electrically connected to the host and display an image frame according to an image signal provided by the host;
an operation device, comprising:
a first light source adapted to emit a first light beam;
a shutter having a plurality of light transmissive areas with different shapes, wherein the shutter is located on a transmission path of the first light beam, the first light beam passes through the shutter to form an operation indicator on the image frame; and
a plurality of function keys electrically connected to the shutter, wherein when one of the plurality of function keys is triggered, the light transmissive area corresponding to the triggered function key is switched to be located on the transmission path of the first light beam, thereby changing a shape of the operation indicator; and
an image capture device adapted to capture the image frame and the operation indicator formed on the image frame.

2. The interactive display apparatus according to claim 1, wherein the image capture device comprises a pattern recognition operation unit, the pattern recognition operation unit is adapted to analyze the image frame having the operation indicator to obtain an analysis result and transmit the analysis result to the host, the host is adapted to display another image frame.

3. The interactive display apparatus according to claim 1, wherein the host comprises a pattern recognition operation unit, the pattern recognition operation unit is adapted to analyze the image frame having the operation indicator to obtain an analysis result, and the host is adapted to display another image frame according to the analysis result.

4. The interactive display apparatus according to claim 1, wherein the first light beam emitted by the first light source is visible light or invisible light.

5. The interactive display apparatus according to claim 1, wherein the operation device further comprises a second light source, the second light source is adapted to emit a second light beam, the first light beam is visible light, and the second light beam is invisible light.

6. The interactive display apparatus according to claim 1, wherein the plurality of function keys comprise a first function key and a second function key, the plurality of light transmissive areas comprise a first light transmissive area with a first shape and a second light transmissive area with a second shape, wherein when the first function key is triggered, the shutter correspondingly rotates to switch the first light transmissive area with the first shape to a first position and to switch the second light transmissive area with the second shape from the first position to a second position, wherein when the second function key is triggered, the shutter correspondingly rotates to switch the second light transmissive area with the second shape from the second position to the first position, wherein the first position is located on the transmission path of the first light beam.

7. The interactive display apparatus according to claim 1, wherein the operation device further comprises:
a control unit electrically connected to the plurality of function keys and issues a control signal in response to one of the plurality of function keys being triggered; and
a drive unit electrically connected to the shutter and the control unit, wherein the drive unit receives the control signal to drive the shutter to rotate thereby switching the light transmissive area of the shutter corresponding to the triggered function key to be located on the transmission path of the first light beam.

8. The interactive display apparatus according to claim 1, further comprising:
a projection surface adapted to display the image frame; and
at least one detection light source for emitting a detection light beam to detect the projection surface, wherein the image capture device senses a reflection light of the detection light beam reflected by a touch object, and the host determines a touch position of the touch object according to the reflection light.

9. An operating method of an interactive display apparatus, the interactive display apparatus comprising a display device, an operation device and an image capture device, wherein the operation device comprises a shutter and a plurality of function keys, and the shutter has a plurality of light transmissive areas with different shapes, and the operating method comprising steps of:
controlling the display device to display an image frame;
controlling the operation device to emit a first light beam on the image frame;
forming an operation indicator on the image frame after the first light beam passing through the shutter;
triggering one of the plurality of function keys of the operation device to switch the light transmissive area corresponding to the triggered function key to be located on a transmission path of the first light beam, thereby changing a shape of the operation indicator; and
controlling the image capture device to capture the image frame and the operation indicator formed on the image frame.

10. The operating method of the interactive display apparatus according to claim 9, further comprising steps of:
analyzing the image frame having the operation indicator to obtain an analysis result; and
controlling the display device to display another image frame according to the analysis result.

11. The operating method of the interactive display apparatus according to claim 9, wherein when a first function key of the plurality of function keys is triggered, a first light transmissive area with a first shape of the plurality of light transmissive areas is switched to be located on the transmission path of the first light beam, wherein when a second function key of the plurality of function keys is triggered, a second light transmissive area with a second shape of the plurality of light transmissive areas is switched to be located on the transmission path of the first light beam.

12. An operation device adapted for an interactive display apparatus, the operation device comprising:
a first light source adapted to emit a first light beam;
a shutter having a plurality of light transmissive areas with different shapes, wherein the shutter is located on a transmission path of the first light beam, the first light beam passes through the shutter to form an operation indicator on an image frame; and
a plurality of function keys electrically connected to the shutter, wherein when one of the plurality of function keys is triggered, the light transmissive area corresponding to the triggered function key is switched to be located on the transmission path of the first light beam, thereby changing a shape of the operation indicator.

13. The operation device according to claim 12, wherein the image frame is displayed by a display device according to an image signal provided by a host.
